(19) United States
(12) Patent Application Publication
(10) Pub. No.: US 2013/0204775 A1
(43) Pub. Date: Aug. 8, 2013

(54) METHODS AND APPARATUS FOR VALIDATING FILES FOR AN ELECTRONIC PAYMENT SYSTEM

(71) Applicants: Sharon P. Midkiff, Chicago, IL (US); Jason K. Wong, (US); Jeffrey Grivno, Fayetteville, GA (US); Gregory Stanford, Jacksonville, FL (US); Rupert A.V. Russell, Patrington Hull (GB)

(72) Inventors: Sharon P. Midkiff, Chicago, IL (US); Jason K. Wong, (US); Jeffrey Grivno, Fayetteville, GA (US); Gregory Stanford, Jacksonville, FL (US); Rupert A.V. Russell, Patrington Hull (GB)

(73) Assignee: Bank of America, Charlotte, NC (US)

(21) Appl. No.: 13/365,514

(22) Filed: Feb. 3, 2012

(51) Int. Cl. G06Q 20/38

(52) U.S. Cl. 705/39

(57) ABSTRACT

A method and apparatus that validates source files for processing by a payment clearing system. Source files may include one or more electronic payment instructions may be provided by a customer. The source file may be pre-processed to remove extraneous data. Next, records in the source file may be validated. The validated may be mapped into payments fields. The normalized payment fields may be normalized into an abstract form or a format agnostic form. The normalized form of the source file information may be validated for processing by a payment clearing system. If the source file information is valid, the valid information may be used request a transfer by the payment clearing system. Finally, one or more reports describing validation results, indicting a correct source file or acknowledgment of a successful transfer may be sent to the customer. Various levels of detail may be included in the report(s).

### FIELD OF TECHNOLOGY

Aspects of the disclosure relate to an electronic payment system. An electronic payment system may provide electronic transfers of funds between entities—e.g., between two banks.

### BACKGROUND

For the purpose of this application, a payment of funds may include wire transfers, one day settlement transfers and/or any other suitable transfers. It should be noted that transfers may be in different currencies and may require currency conversion.

Wire transfers or credit transfers are typical electronic methods for the transfer of funds from one person, institution or other entity to another. A wire transfer can be made from one bank account to another bank account or through a transfer of cash at a cash office.

Central wire transfer systems, such as the Federal Reserve's FedWire system in the United States typically operate as Real Time Gross Settlement (“RTGS”) systems. RTGS systems provide the quickest availability of funds because they provide immediate “real-time” and final “irrevocable” settlement by posting a gross entry against electronic accounts of a wire transfer system coordinator.

A wire transfer may be effected as follows: The entity wishing to do a transfer approaches a bank and gives the bank the order to transfer a certain amount of money. An international bank account number (“IBAN”) and/or other codes are given as well so the bank knows where the money needs to be sent. The sending bank transmits a message, via a secure system (such as SWIFT or Fedwire), to the receiving bank. The message may provide payment instructions. The message may include settlement instructions. The actual transfer may not be instantaneous: funds may take several hours or even days to move from the sender's account to the receiver's account. Either of the banks involved typically holds a reciprocal account with each other, or the payment must be sent to a bank with such an account, a correspondent bank, for further benefit to the ultimate recipient.

The electronic transfer process may involve complex source files. Errors generated by flawed source files may be difficult to detect and understand. Attempts to integrate electronic transfer systems with a bank customer's systems may require skilled personnel and may consume time and other resources. Failed transfers may generate late payment penalties or loss of trust. Therefore, a system that validates source files prior to submission to electronic payment systems is desirable during system implementation and during system use.

### SUMMARY

A source file validation system for an electronic payment system may be provided by a customer. Validation of the source file indicates that correct processing by an electronic transfer system or a network of electronic transfer systems is expected. Source files may include one or more electronic payment instructions. Source files may be provided by a customer or a customer's software application.

Source files may be pre-processed to remove extraneous data. Next, records and fields in the source file may be validated. Validated records may be normalized into an abstract form or a format agnostic form. The abstract form of source file information may be validated for processing viability by an electronic transfer system. If the source file information is valid, the valid information may be used to effect a transfer by the electronic payment system. Finally, one or more output files such as validation reports, sample acknowledgments files, and sample information report files may be generate and sent to the customer.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 shows a schematic diagram of an exemplary electronic payment system including validation according to the invention;

FIG. 3 shows an architectural diagram for an exemplary validation system according to the invention;

FIG. 4 shows a schematic diagram for a portion of an exemplary validation system according to the invention; and

FIG. 5 shows a schematic diagram for a portion of an exemplary validation system according to the invention.

### DETAILED DESCRIPTION OF THE DISCLOSURE

Apparatus and methods for facilitating electronic transfer payments are provided. The payments may be executed by an originating bank on behalf of a customer of the originating bank. The originating bank may transmit a payment via a payment clearance system to a receiving bank. The customer may use a source file to instruct the originating bank to execute the payment. The apparatus and method may be used to validate the source file. Validation may facilitate passage of the payment through the payment clearance system.

The apparatus may include a processor module and a memory that stores instructions. The instructions may be configured to: map a field from the source file or from multiple source files to a payment field, normalize the payment field and validate the normalized payment field as acceptable by the electronic payment system.

The mapping may include mapping the field into one or more portions of a payment field. The mapping may include discarding a portion of the field. The field may include a plurality of elements. The mapping may include changing the order of the elements. The mapping may include updating a portion or an element of the field. The instructions may be configured to validate the field. The field may be a portion of a record and the instructions may be configured to validate the record.

The payment field may be a plurality of elements and the normalization may include re-ordering the plurality of elements. The field may be a format-specific field. The payment field may be a format-agnostic rendering of the contents of the format-specific field.

Source file(s) which may include one or more electronic payment instructions may be provided by the customer or the customer's application software. Source file(s) may be format specific. Source files may be formatted according to mutually accepted format specifications. The instructions may be configured to pre-process the source file. The source file may a fixed width file, a character delimited file or a XML file.

Validation of a source file indicates that correct processing by an electronic payment system is expected. The validation process may be used in an implementation scenario, in which a customer integrates her or his software with one or more electronic payment systems or bank systems. In an alternative scenario, source files may be validated prior to entry into the electronic payment system to prevent erroneous transfers and to prevent poor or erroneous utilization of the electronic payment system.

In some implementation scenarios, one or more reports indicating errors in the source file or indicating a correct source file may be sent to the customer. Reports at various levels detail may be generated. In some scenarios, validation occurs prior to use of the electronic payment system to prevent errors. If the source file produces errors, reports are returned to the customer and the electronic payment is not attempted. If the source file is valid the electronic payment is effected and an acknowledgment response may be sent to the customer either by the validation system or by the electronic payment system.

The acknowledgment may include a reference number so that payment can be confirmed and tracked. The reference number may be accompanied by additional information to facilitate tracking of the payment by the payee. Typically, a wire transfer cannot be reversed; therefore, the reference number may be considered proof of payment. If the payment is used to purchase goods or services, these items may be released upon receipt of the reference number.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash devices and/or any combination thereof. In addition, various signals representing data or events as described herein may be transferred between a source and a destination in the form of electromagnetic waves traveling through signal-conducting media such as metal wires, optical fibers, and/or wireless transmission media, e.g., air and/or space.

Data may move between various entities in any of the embodiments of the invention via electronic transmission or manual means. Electronic transmission may utilize email, SMS or any other suitable method. Manual exchange may utilize floppy disks, USB drives, CDs, DVDs or any other suitable mechanism.

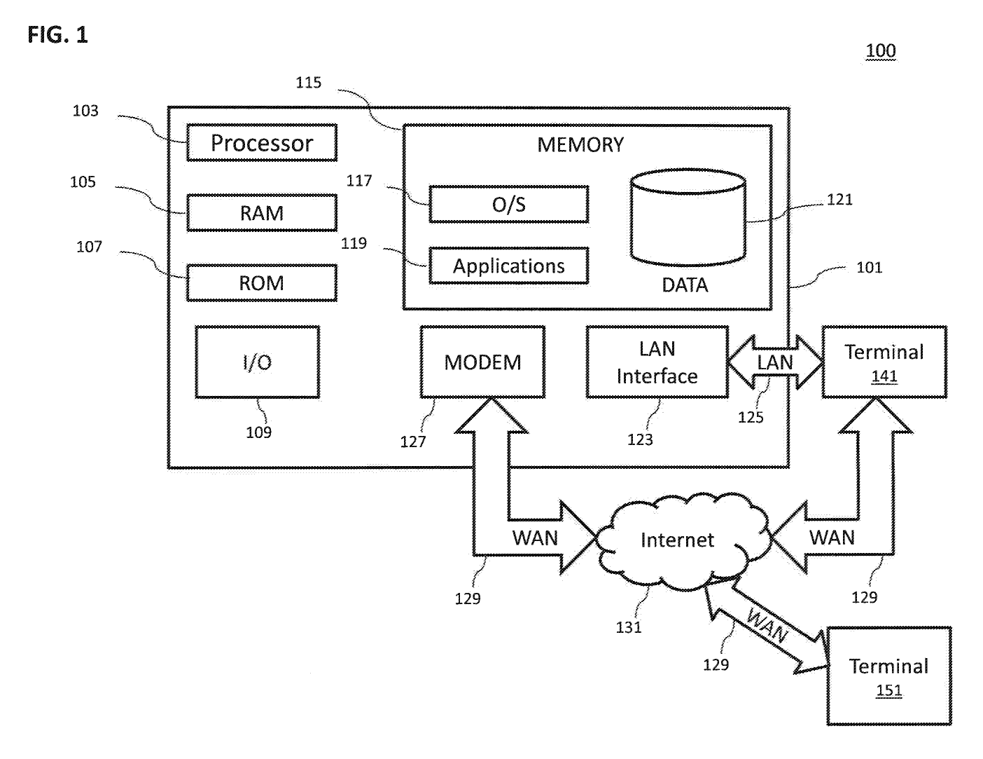

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115. Server 101 may include one or more receiver modules, server modules and processors that may be configured to transmit and receive payments, wire transfers, payments via checks, debit cards, credit cards, lines of credit or any suitable credit instrument. Likewise, server 101 may be configured to transmit and/or receive information and to provide from/to an Enterprise Resource Planning (“ERP”) or any other suitable system. Further, server 101 may provide confirmation information to one or more payees and facilitate payment validation processing and perform any other suitable tasks related to treasury an electronic payment system.

Input/output (“I/O”) module 109 may include a microphone, keypad, touch screen, and/or stylus through which a user of device 101 may provide input, and may also include one or more speakers for providing audio output and a video display device for providing textual, audiovisual and/or graphical output. Software may be stored within memory 115 to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for customer information, invoices, approvals and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129 and/or Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, smartphone, iPhone, or any other suitable device for storing, transmitting and/or transporting relevant information.

Any information described above in connection with database 121, and any other suitable information, may be stored in memory 115.

One or more of applications 119 may include one or more algorithms that may be used to perform one or more of the following: file validation, treasury operations, wire transfers and any other suitable tasks.

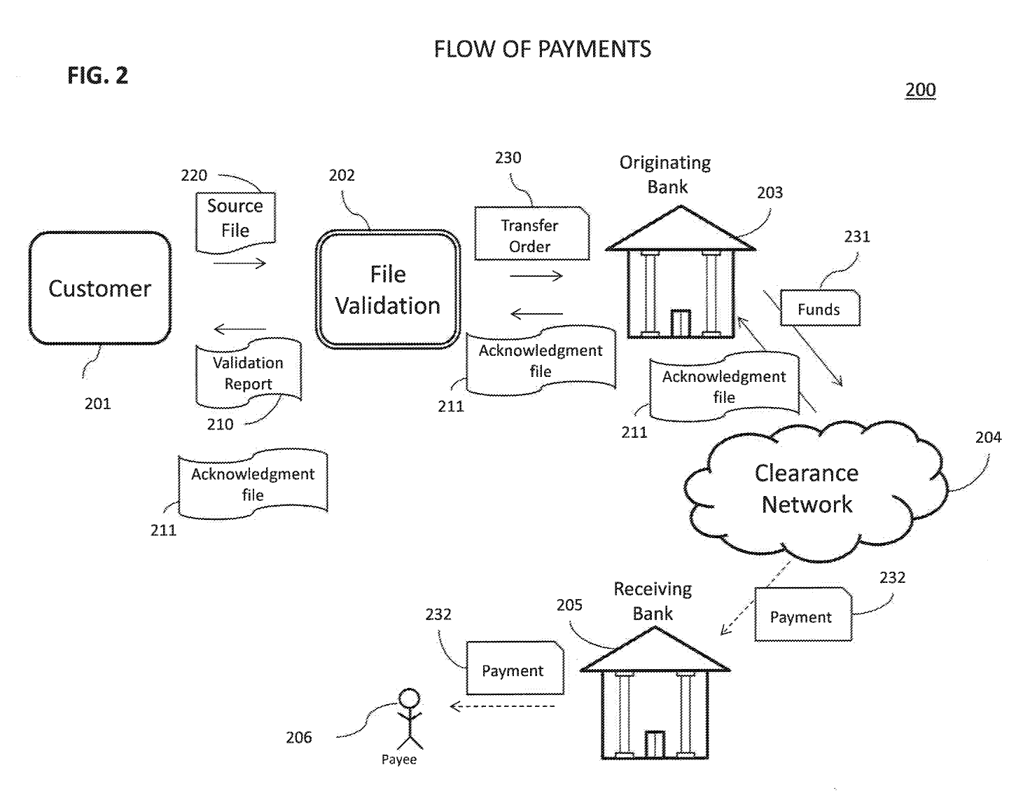

FIG. 2 shows a schematic diagram of an exemplary electronic payment system 200 including an embodiment of validation of source file(s) according to the invention. Payments may include transfers or any other suitable transaction. Typically customer requests are processed in a straight through process (STP) or straight through fashion—i.e., without manual intervention.

One or more source file(s) 220 may be created by customer 201. Customer 201 may be an ERP such as a Systems Analysis and Program development (“SAP”), an Oracle™ system or any other suitable system. In the alternative, source file(s) 220 may be created by a person instead of a software system.

In an exemplary embodiment of the invention source file(s) are sent to file validation system 202. File validation system 202 may be part of an active electronic payment system or it may be part of an acceptance testing process used for during implementation or during system development. Validation system 202 may be part of originating bank's 206 software systems.

In response to source file 220, file validation system 202 may send validation report 210 to customer 201. Validation report 210 may include an executive summary of validation results—e.g., validation errors—, a detailed description of file syntax errors, and/or description of file syntax and payment field errors.

Validation report 210 may be accompanied by acknowledgement file 211. Acknowledgement file 211 may be synthesized by file validation system 202 or it may be a report generated by systems within originating bank 206 and/or by a payment clearing system 204. Acknowledgement file 211 may describe errors in transfer order 230. Acknowledgement file 211 may be in a well known format such as flat file, IDOC STAT, SWIFT MT900/910 or an email. Likewise, acknowledgement file 211 may include information reports such as BAI2 or SWIFT MT940/942 files.

If the errors found by validation system 202 can be corrected, and/or the errors are inconsequential, a valid source file may be constructed and used by file validation system 202 to complete the transfer.

File validation system 202 may send a validated source file 230 for further processing 203 within originating bank 206. If the source file is valid then the originating bank 206 may generate a transfer order 231, which corresponds to a validated source file 230. In the alternative source file 220 becomes transfer order 231. Transfer order 231 may initiate payment of funds by payment clearing system 204. Transfer order 231 may be validated source file 230. Transfer order 231 may be in a standard form—e.g., SWIFT MT101.

Payment clearing network 204 may send acknowledgement file 211 in response to transfer order 231 to originating bank 206. Acknowledgement file 211 may describe errors found in funds 231.

Clearing system 204 may provide payment 232 to receiving bank 205 in response to transfer order 231. Receiving bank 205 may provide payment 232 to payee 207. Sending of payment 232 to payee 207 completes the transfer of funds via the electronic payment system. All payments, reports, funds, and files may be transferred by electronic, manual or any other suitable means.

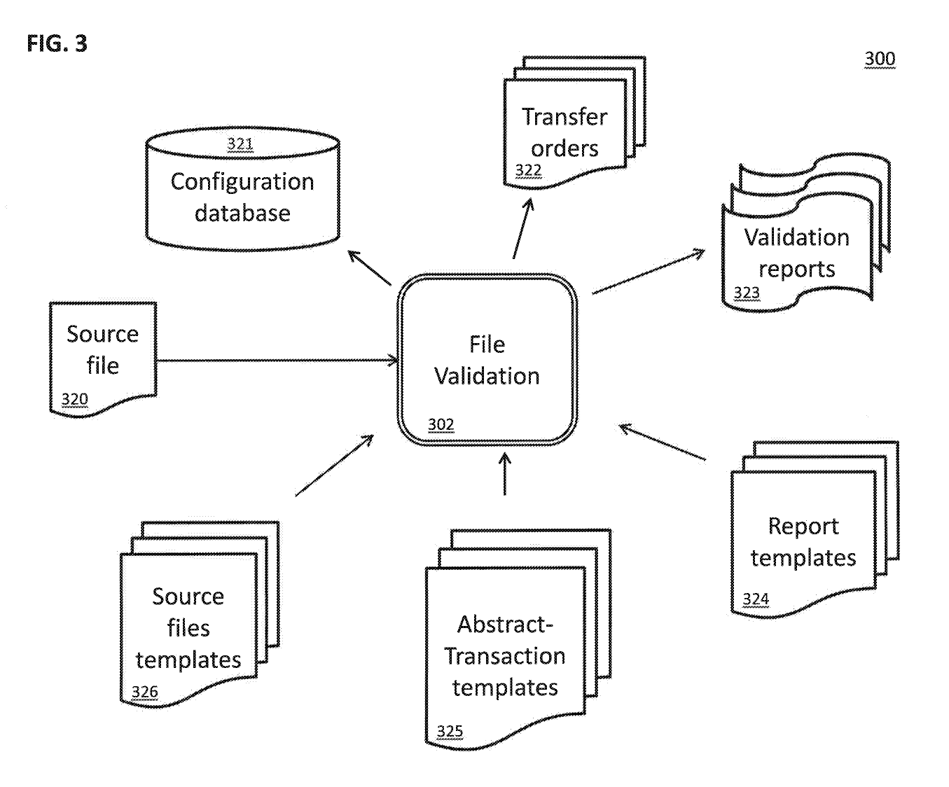

FIG. 3 shows an architectural diagram 300 for an exemplary validation system according to the invention. File validation system 302 receives source file 320 for validation. Source file 320 may be formatted as an unwrapped file, a file wrapped by character length or wrapped by record length or any other suitable file format. In addition, source file 320 may be described by a detailed file format that dictates the layout of source file 320 or may conform to an agreed upon format specification.

Validation system 302 may also validate intermediate files. Intermediate files may be payment files generated by internal bank systems based on client system files—e.g., a customer remittance file (CRF).

Source file 320 may be a collection of groups and/or a collection of records. A group may be a collection of related transactions. A transaction may describe a transfer or a payment. A payment may be a specific type of transaction. Source file 320 may include a single transaction or it may include multiple transactions.

A record may be a collection of related fields. A field may be a set of characters corresponding to a specific piece of information—e.g., a currency, an originating bank or an account number. Fields may be format-specific and may be defined in file format definitions 326 or fields may be payment fields that may be defined in a payment system—e.g., payment clearing system 204.

Source files may be described by a File Format Definition (FFD) or definitions. A FFD may describe the layout of a file format in a way that the file structure can be understood by the validation system 302. A FFD may include record validation and format-specific field validation requirements. An FFD may include mapping logic for mapping format-specific fields to payment fields.

Results may be compiled into a dataset which includes validation results of a source file(s). The date may be organized into the following categories: summary information, format-specific validation results, payment field validation results, record information and payment field mapping information. The results dataset may be used as the source for generating output files.

A payment file, which may be the result of a mapping and normalization process, may have a four level hierarchy; file level, group level, transaction level and transaction addenda level. Transaction addenda belong to, or a contained within, transactions. Transactions belong to groups and groups belong to files.

There may be several record types: e.g. file header, group header, transaction, transaction addenda, group addenda, group trailer, file trailer and filler. A record may have a record type specified for it in the FFD so that the file validation system knows where it is in the payment file hierarchy.

There may be several keywords that are used within an FFD. One example of a keyword is “counter”. A counter may be a numeric variable that is either provided by the system or are defined within an FFD. A record may subscribe to zero or more counters. Whenever an instance of the record occurs in the file, the subscribed counters increment by a numeric value defined for that counter. A counter may be used as a parameter for format-specific field validation tests.

Another keyword is “total,” which may be a numeric variable that is either provided by the system or defined within an FFD. A format-specific field may subscribe to zero or more totals. Whenever an instance of the field occurs in the file, the subscribed totals may be increased by the numeric value derived from the field's value. File-level totals may be defined and mayor may be reset throughout the validation of the entire file. Group-level totals may be defined and may be reset to 0 whenever a new group is encountered. Transaction-level totals may be defined and may be reset to 0 whenever a new transaction is encountered. Totals may be used as a parameter for format-specific field validation tests.

Another keyword is “stored value,” which may be a variable that may be defined within an FFD. A format-specific field may subscribe to zero or more stored values. Whenever an instance of the field occurs in the file, its value may overwrite the value of each subscribed stored value. Stored value may be used as a parameter for format-specific field validation tests.

A “payment field” may be a piece of data that has a specific business purpose in the initiation of a batch of payment transactions or a single payment transaction. A payment field in the file validation system may or may not be specific to any file format. Payment fields may be defined at the file, group, and transaction levels of the payment file hierarchy. FFDs may include mapping definitions that instruct the File Validation System on how to populate payment fields.

Each format-specific field may have zero or more tests defined for it. Each format-specific field validation test has zero or more conditions that are evaluated by the file validation system 302 to determine if the validation test should be run. A condition contains an expression that will evaluate to either a logical TRUE or a logical FALSE. Supported operators for expressions may include: equals numeric value, is same as text value, is greater than numeric value, is greater than or equal to numeric value, matches regular expression pattern, does not equal numeric value, is not the same as text value, is less than numeric value and is less than or equal to numeric value.

The left-side and right-side values for the evaluation may need to be specified. Validation tests may be run if and only if all the conditions evaluate to TRUE. In the alternative validation tests may be run in some or none of the conditions evaluate to TRUE.

File validation system 302 may support a number of different testing methods for a format-specific field value: matches a specified regular expression pattern, is the same as text value, is a valid date and time representation, is empty, is a weekday, has the same value as a keyword—i.e., total, counter, or stored value, has the same value as the modulo calculation of a keyword, has the same value as a specific portion of the keyword, is greater than the value of a keyword, is one of the values within a specified list, is within a numeric range (inclusive of the minimum and maximum values), is within a numeric range (exclusive of the minimum and maximum values), passes always and any other suitable tests.

The reverse/negation of each test method may also be available. Each validation test may have its own unique error message. A format-specific field may be said to have passed validation if and only if no validation tests fail. A success message code may be associated with a format-specific field's validation tests. In the alternative a success message code may be associated with multiple format-specific field's validation tests.

A format-specific field definition may contain zero or more payment field mapping definitions. That is, one format-specific field may be used to populate the values of multiple payment fields. A mapping definition may have several settings: the payment field to update and formatting, update condition, update method, specify character(s) to join values in append and prepend update method and value manipulation.

Formatting may have options such as: providing the decimal mark character for numeric amounts, providing the number of implied decimal places and proving the date and time format.

Update condition may have options such as: always update, only update if the format-specific field is not all zeros and only update if the format-specific field is not all spaces.

Update method may designate: add the format-specific field value to the current value of the payment field, subtract the format-specific field value from the current value of the payment field, append the format-specific field value to the current value of the payment field, prepend the format-specific field value to the current value of the payment field and replace the current value of the payment field with the value of the format-specific field.

Value manipulation may specify a substring or specify a subset of the format-specific field value to use for the update. Value manipulation may trim spaces—e.g., remove leading and/or trailing spaces from the from the format-specific field value before performing the update.

Payment field values derived from the payment field mapping process may not be suitable for a payment field validation process. This may occur, for example, because values might still be format-specific or the payment field mapping process may create payment field values that need to be cleaned. Payment field normalization my include the process of converting payment field values to format-agnostic and/or cleaned values in preparation for the payment field validation process.

A transaction type may be a unique combination of transaction currency, payment method, and ordering branch. Payment field validation tests may be grouped by transaction type. A transaction type definition 325 may specify whether or not a transaction type is allowed. A transaction type definition may describe all the payment field validation tests for a transaction type.

Each payment field validation test may have zero or more conditions that are evaluated by the file validation system 302 to determine if the validation test should be run.

Each condition may contain an expression that will evaluate to either logical TRUE or logical FALSE. The supported operators for expressions include: equals numeric value, has the same date and time, is same as text value, is greater than numeric value, is greater than or equal to numeric value, matches regular expression pattern, does not equal numeric value, is not the same as text value, is less than numeric value and is less than or equal to numeric value.

The left-side and right-side values for the evaluation of a condition may or may not be specified. Validation tests may be run if and only if all the conditions evaluate to TRUE. In the alternative validation tests may be run in some or none of the conditions evaluate to TRUE.

A payment field validation test may implement one of the following tests: matches a specified regular expression pattern, is the same as a text value, is empty, is a weekday, is within a number of weekdays of another payment field, is one of the values within a specified list, is within a character length range, is within a numeric range (inclusive of the minimum and maximum values), is within a numeric range (exclusive of the minimum and maximum values and passes always.

The reverse/negation of any of the payment field validation test methods may be available. Each payment field validation test may have its own unique error message. A payment field is said to have passed validation if and only if no validation tests fail. A success message code can be associated with a payment field's validation tests. In the alternative a success message code may be associated with multiple payment fields' validation tests.

A report definition(s) 324 may contain information that is used by the file validation system 302 to generate reports. Report definition(s) may include file types: PDF, XLS, TXT and TIF, filename information and Microsoft® RDLC report definition. Report definition(s) 324 contain other information used for display purposes.

Source file format definitions 326 may describe the layout and requirements for records, groups, transactions and format-specific fields. File format definitions 326 may also include payment field definitions. Payment field definitions may describe the assembly of payment fields. A single source file field, typically a format-specific field, may be used to populate one or more than one payment field(s). Likewise, a payment field may be populated by one or more than one format-specific fields.

File validation system 302 may use file format definitions 326 and transaction type definitions 325 to validate source file 320. Report definitions 324 may be used to define the look and feel of reports issued by file validation system 302.

File validation system 302 may generate one or more validation reports 323. Validation reports 323 may be detailed description of validation results from the processing of source file 320. Validation reports 323 may include a high level description and accounting for errors in source file 320 or a confirmation of an acceptable source file 320 as described above with in relation to validation report 211. Different reports may be generated depending on the nature of the errors, or lack thereof, the requirements of customer 201 or any other suitable requirements.

Validation system 302 may generate miscellaneous files (not shown) such as guides, clearing times, file specifications, debit authority listings, format detections and number of record per line descriptions or any other suitable file.

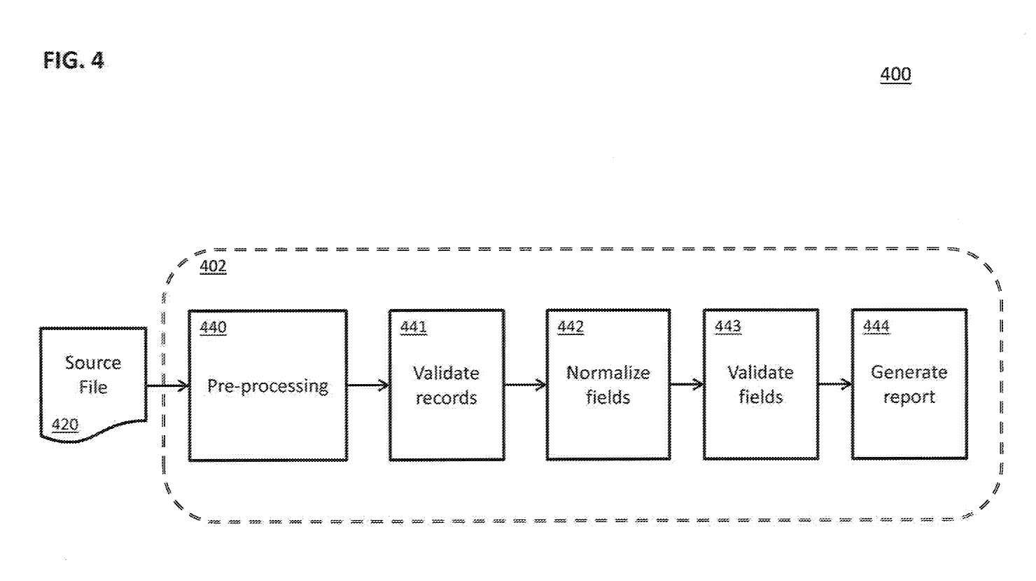

FIG. 4 shows a schematic diagram for validation system 400 showing the stages of an exemplary validation process according to the invention. Source file 420 may be submitted to file validation system 402. Source files may be in a wrapped-by-record length file type, wrapped-by-character length file type or an unwrapped file type. Each of the these file types may encompass a fixed width format, a character delimited format, XML or any other suitable format. Exemplary fixed width formats may include America's local formats, Asia local formats, EMEA local formats, SWIFT MT, flat file format, IDOC, CRF and various cheque formats. Exemplary character delimited formats are ASC X12, EDIFACT formats or an suitable CSV format. An exemplary XML format is ISO 20022.

File validation system 402 may begin with file pre-processing (FPP) step 440. FPP step 440 may remove blank lines and any extraneous characters according the format of source file 420. Additional information for pre-processing source file 420 may be found in a file format definition such as file format definitions 326 shown in FIG. 3.

Next, at step 441, an abstract file may be initialized. Abstract file initialization, may create a set of file-level payment fields. Default values may be given to the payment fields if they are specified in the FFD. Group initialization may create a new set of group-level payment fields as a 2nd level (see level description above) to the abstract file. Default values for group-level payment fields may be given to the payment fields if they are specified in the FFD. Transaction initialization may create a new set of transaction-level payment fields under a group as a 3rd level to the abstract file. Default values for group-level payment fields may be give to the payment fields if they are specified in the FFD.

Next, at step 450 file format specific processing is performed. First, the file type may be determined. Each of wrapped-by-record length files, wrapped-by-character length files and unwrapped files may be processed accordingly. The records and fields of file 420 may be validated using one or more file format definitions 326. Step 450 may be skipped.

At step 443, payment-specific fields may be mapped to payment fields—i.e., payment field mapping (PFM). Mapping may be according to one or more file format definitions 326.

Next at step 444, payment fields are normalized (PFN). Normalization typically reformats format specific fields of the source file 420 into format agnostic fields. The fields resulting from the normalization process are payment fields. Normalization procedures may be derived from using one or more file format definitions 326.

Next, at step 444, the normalized payment fields are validated (PF). Payment fields may be validated according to one more transaction type definitions 325. Typically, the payment type associated with a payment field will be identified as a combination such as payment method, traction currency and ordering branch. Each unique collection of payment method, traction currency and ordering branch may have one or more definitions that may be used to validate some or all of the payment fields derived from source file 420.

In the alternative the fields of source file 420 are not normalized and format-specific (non-normalized) fields are validated using file format definitions 326 at step 450.

A validation report or reports 410 may be generated. The reports may be similar to one or more validation reports 323 as described above in relation to FIG. 3. A validated file 430 may be generated as a result of the validation processing. Validated file 430 may be suitable for processing by an electronic payment system.

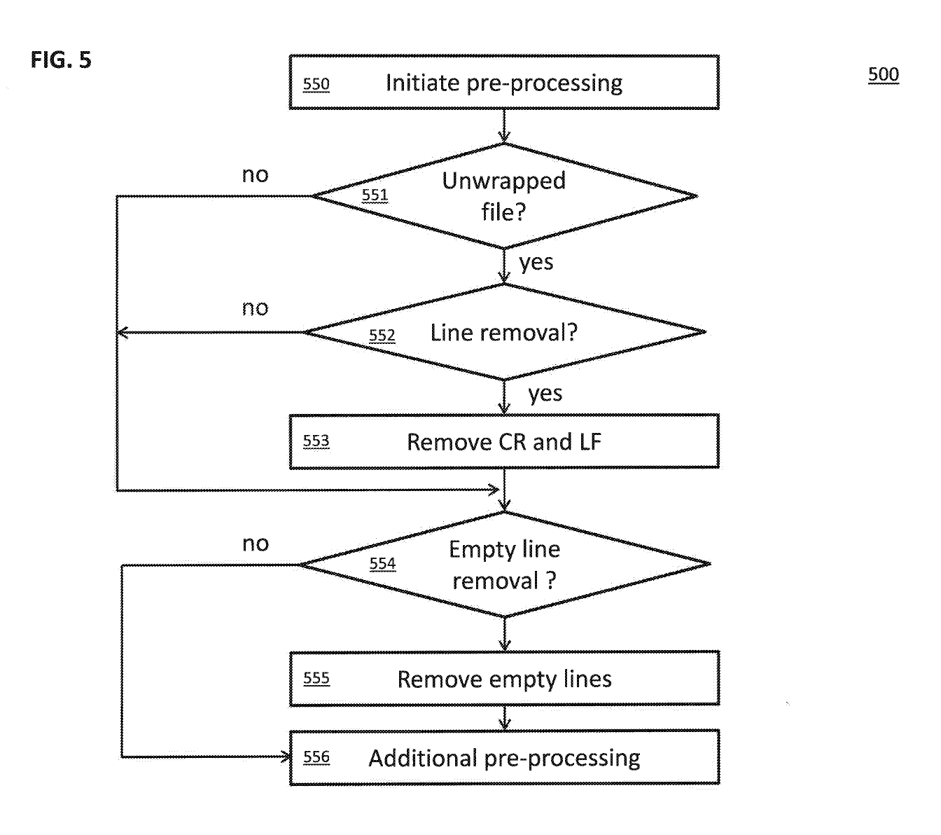

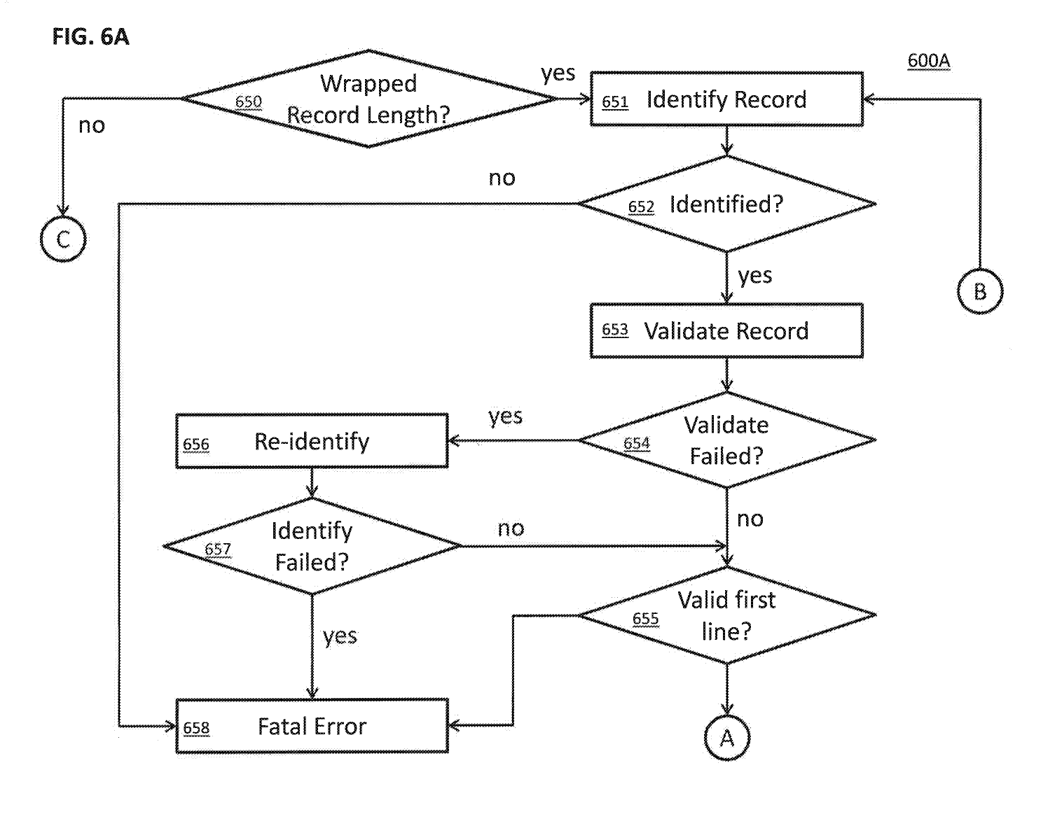

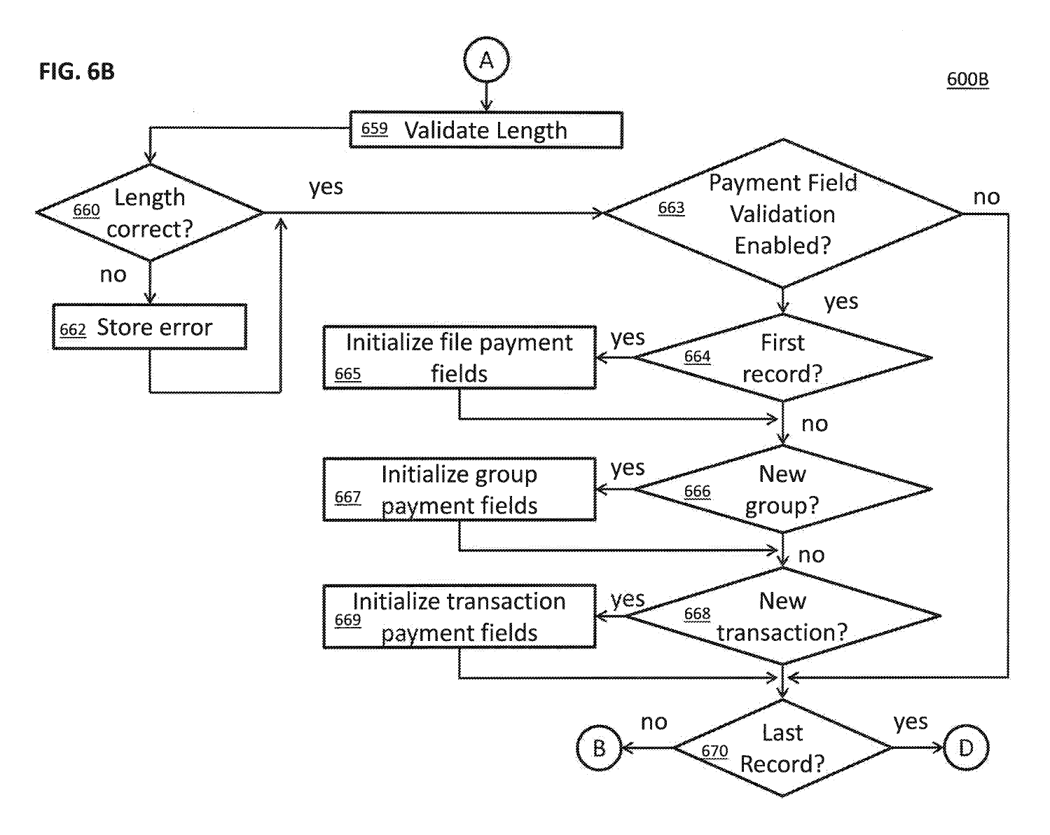

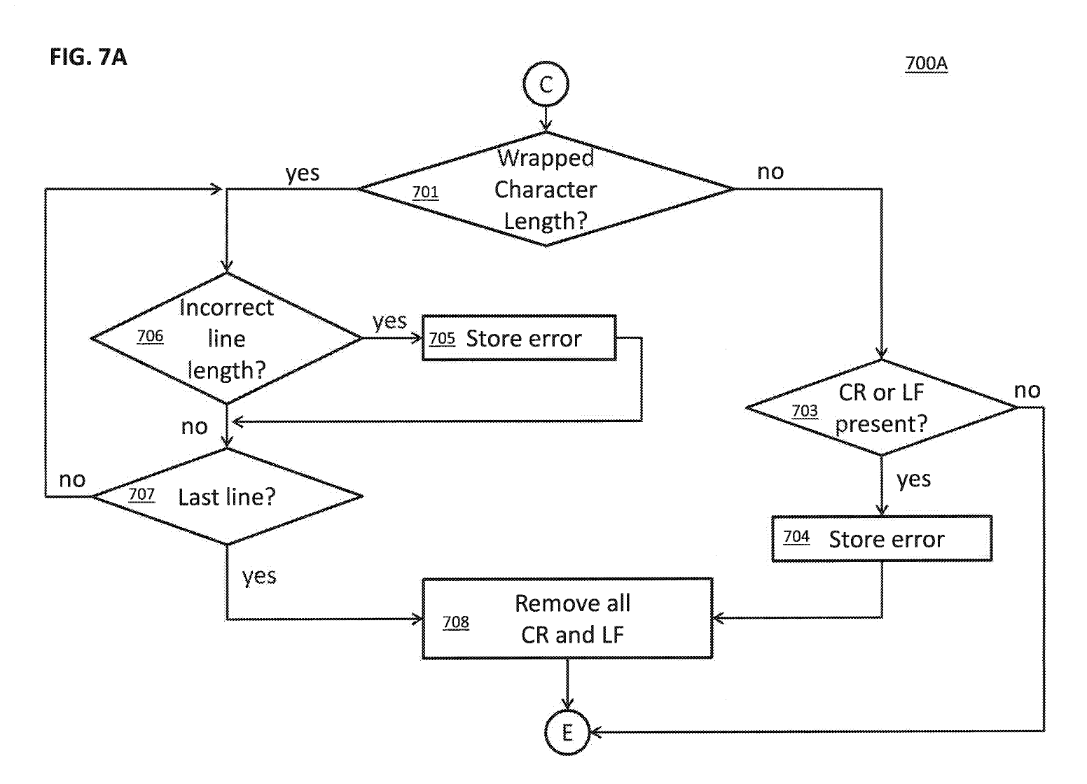

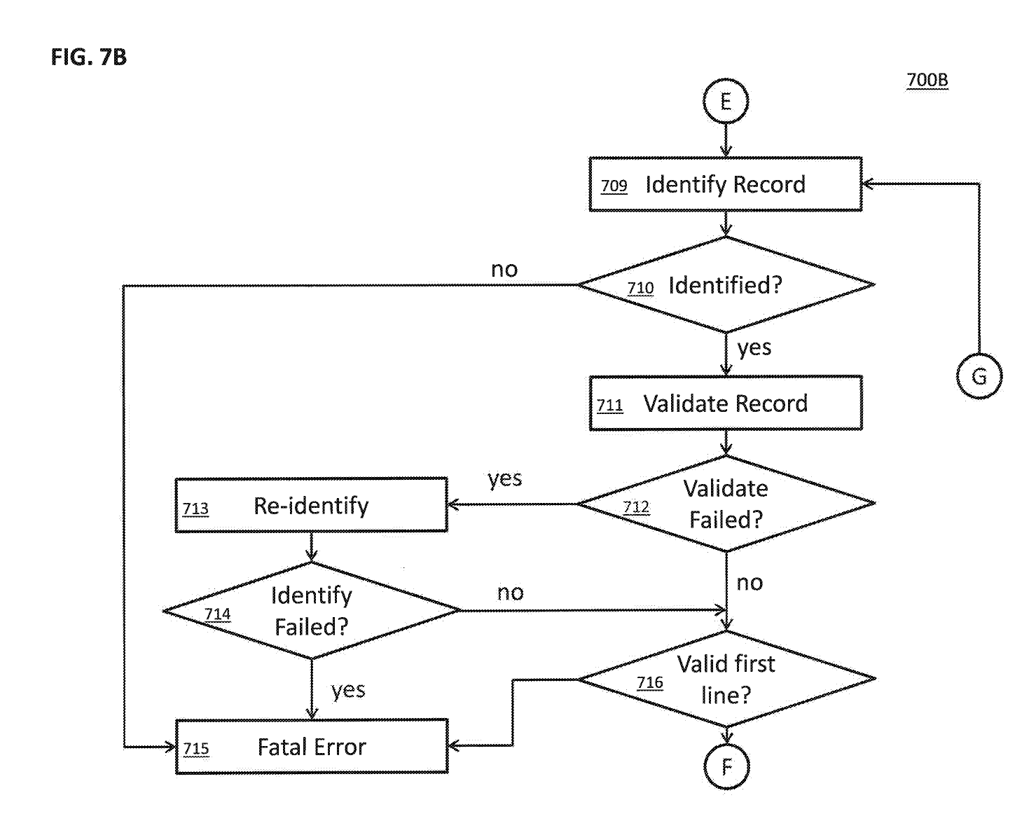

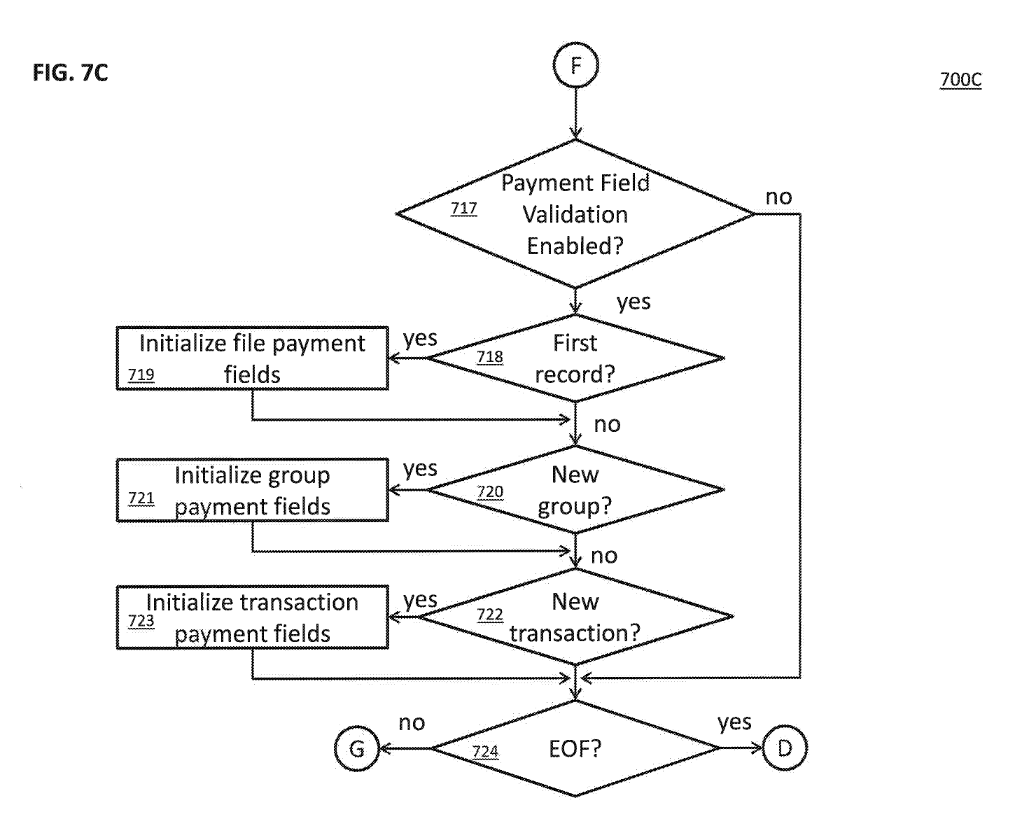

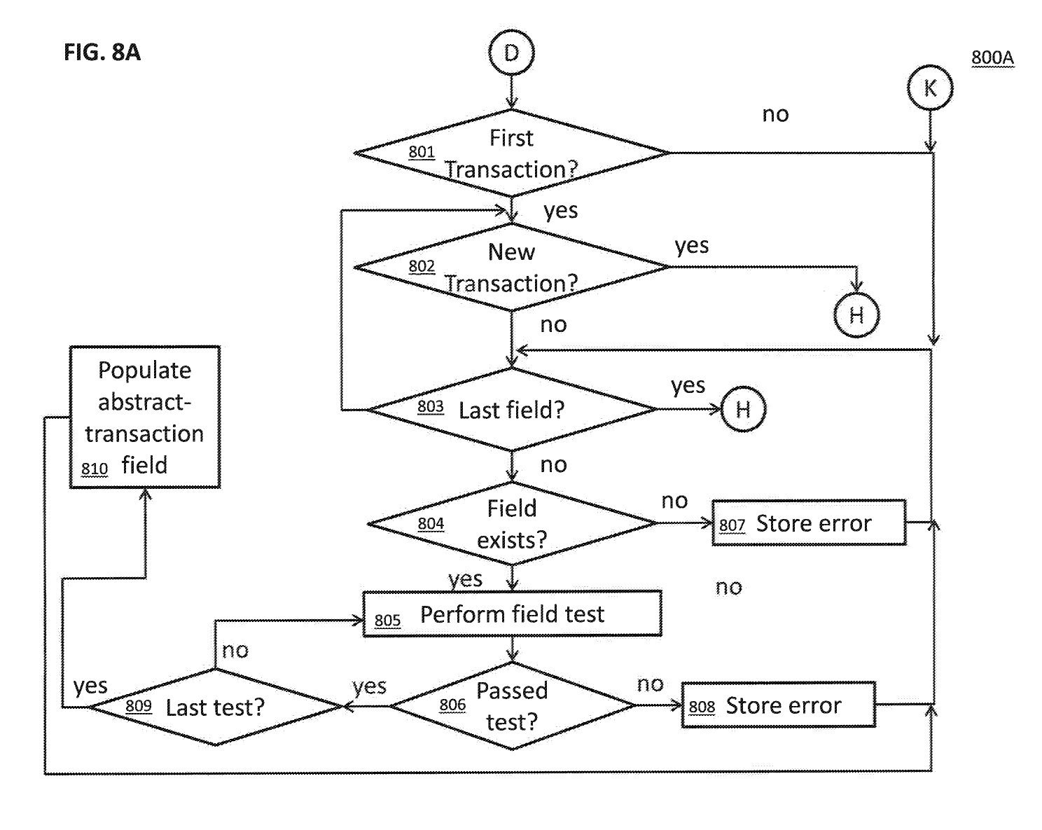

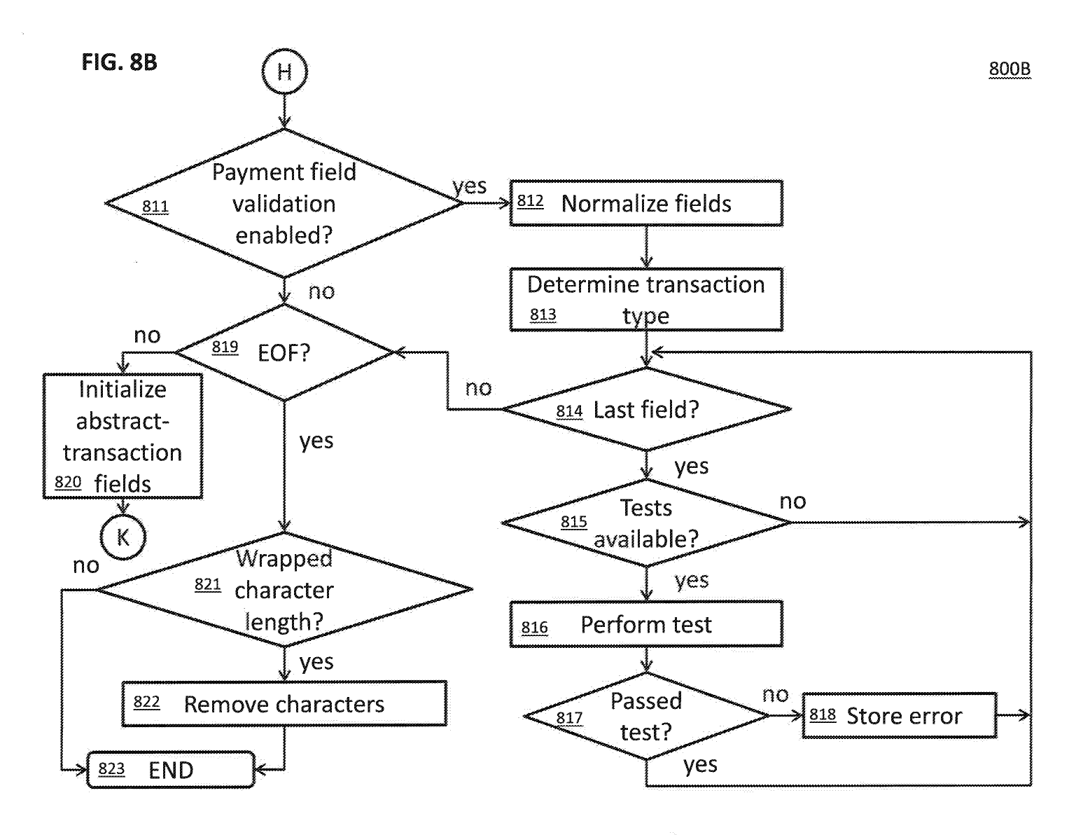

FIG. 5 shows a flow chart of exemplary file format processing block 500, which may correspond to step 450 shown in FIG. 4. First the source file 420 type is determined. Source file(s) 420 may be a wrapped-by-record length file type, wrapped-by-character length file type, an unwrapped file type, or any other suitable file type. If source file 420 is a unwrapped file type, then unwrapped file processing (UFP) takes place at step 453. If source file 420 is a wrapped-by-character length file type, then wrapped-by-character length file type processing (WCLFP) takes place at step 452 followed by UFP at step 453. If source file 420 is a wrapped-by-record length file type, then wrapped-by-record length file processing (WRLP) takes place at step 451.

After file processing is complete at steps 453, 452 and 453 or 451, record processing (RP) may take place at step 454. Format-specific field processing may take place at step 455. The processed fields may now be ready for mapping to payment fields at step 443.

Each step in validation process described in FIG. 4 and FIG. 5 may be accomplished via an exemplary embodiment of the invention described below in pseudo-code. Each step in the figures has a corresponding section of pseudo-code. A main program block, shown first, orchestrates the execution of the pseudo-code. Each step in executed in order. Some steps are only executed if a condition is true. If the condition is not true then the next unconditional step is executed.

### Main File Processing for Fixed-Width File Formats (MFP)

1. Perform File Pre-Processing (FPP) on file contents
2. Is payment field mapping or payment field validation enabled in FFD?
   a. Yes: Perform abstract file initialization.
3. Is it specified in the FFD that the file should be wrapped-by-record-length?
   a. Yes: Perform wrapped-by-record-length file processing (WRLFP) on file contents.
4. Is it specified in the FFD that the file should be unwrapped?
   a. Yes: Perform unwrapped file processing (UFP) on file contents.
5. Is it specified in the FFD that the file should be wrapped-by-character-length?
   a. Yes: Perform wrapped-by-character-length file processing (WCLFP) on file contents.
6. Is payment field mapping or payment field validation enabled in FFD?
   a. Yes:
      i. Perform payment field normalization (PFN) on abstract file.
      ii. Perform payment field validation (PFV) on abstract file.
7. For each desired output file:
   a. Using the report definition associated with the output file, create the output file with data sourcing from the Results Dataset.

### File Pre-Processing (FPP)

1. Is it specified in the FFD to remove new-line characters?
   a. Yes: Remove new-line characters from input value.
2. Is it specified in the FFD to remove whitespace lines?
   a. Yes: Remove whitespace lines from input value.
3. Are pre-processing character replacement entries defined in the FFD?
   a. Yes: For each character replacement entry:
      i. For each instance that a value in the file matches the regular expression pattern defined in the replacement entry
         1. Replace the value with the characters specified in the replacement entry

### Wrapped-By-Record Length File Processing (WRLFP)

1. For each separate line of characters in input value:
   a. Can line be identified as a record?
      i. No: Store record identification error in Results Dataset. Exit process and Go to Step MFP.6.
   b. Perform record processing (RP)

### Wrapped-By-Character Length File Processing (WCLFP)

1. For each separate line of characters in input value:
   a. Is number of characters in line correct as defined in FFD?
      i. No: Store error in Results Dataset and continue.
   2. Remove all new-line characters from the input value so that there is only one concatenated line remaining
   3. Perform Unwrapped File Processing (UFP) on the single line

### Unwrapped File Processing (UFP)

1. Is there more than one line in the input value?
   a. Yes: Store error in Results Dataset and continue.
2. Can a record be identified in the input value using record identification criteria in the FFD?
   a. No: Store record identification error in Results Dataset. Exit process and Go to Step MFP.6.
3. Where x represents the number of characters defined (in the FFD) for the identified record, remove x characters from the beginning of input value.
4. Perform Record Processing (RP) on the removed characters.
5. Are there still characters remaining in the input value?
   a. Yes: Go back to Step 2.

### Record Processing (RP)

1. Check if record is out of sequence:
   a. Is record first line in file?
      i. Yes: As defined in FFD, can record be the first line in a file?
         1. Yes: Go to Step 1c.
         2. No: Store record sequencing error in Results Dataset. Exit process and Go to Step MFP.6.
      ii. No: Go to Step 1.c.
   b. As defined in FFD, can the record be the next record to the previous record?
      i. No: Store record sequencing error in Results Dataset. Exit process and Go to Step MFP.6.
   c. Has the record occurred more than the maximum number of times it can occur in sequence (Note: Maximum number of occurrences defined in FFD)?
      i. Yes: Store record sequencing error in Results Dataset. Exit process and Go to Step MFP.6.
2. Does the record have too few or too many characters (as defined in the FFD)?
   a. Yes: Store error in Results Dataset and continue.
3. Is payment field mapping or payment field validation enabled in FFD?
   a. Yes:
      i. Is the record the beginning of a new group?
         1. Yes: Perform group initialization.
      ii. Is the record the beginning of a new transaction?
         1. Yes: Perform transaction initialization within current group.
   b. No:
      i. Go to next step.
4. For each field (of the record) defined in the FFD:
   a. Perform format-specific field processing (FSFP).
5. Update system counters and subscribed FFD-defined counters

### Format-Specific Field Processing (FSFP)

1. Has the field defined in the FFD been provided in the input record?
   a. No:
      i. As defined in the FFD, is the field required?
         1. Yes: Store error in Results Dataset. Exit process.
         2. No: Exit process.
         2. For each defined field validation test
   a. Based on evaluating conditions defined in the FFD, should test be run?
      i. Yes:
         1. Perform test.
         2. Did test pass?
         a. No: Store error message in Results Dataset. Go to Step 4 (i.e. skip remaining tests).
3. Store success message (if specified in FFD) in Results Dataset.

4. Update subscribed FFD-defined totals, FFD-defined stored values, and system totals
5. Is payment field mapping or payment field validation enabled in FFD?
   a. Yes: As defined in FFD, map format-specific field value to payment field(s) (PFM) in abstract file.

### Payment Field Mapping (PFM)

1. For each payment field mapping entry defined (in the FFD) for the format-specific field:
   a. Check Update Condition
      i. Is mapping entry's update condition to update always?
         1. Yes: Go to Step 1b.
      ii. Is mapping entry's update condition to update only if the format-specific field's value is not all zeros?
         1. Yes: Is format-specific field's value all zeros?
         a. Yes: Go back to Step 1 (i.e. Skip this entry & try next one).
         b. No: Go to Step 1b.
      iii. Is mapping entry's update condition to update only if the format-specific field's value is not all spaces?
         1. Yes: Is format-specific field's value all spaces?
         a. Yes: Go back to Step 1 (i.e. Skip this entry & try next one).
         b. No: Go to Step 1b.
   b. Perform Value Manipulation on Format-Specific Field
      i. Is substring requested?
         1. Yes: Shorten format-specific field value to substring requirements.
      ii. Is trim requested?
         1. Yes: Remove leading and/or trailing spaces from format-specific field value
   c. Update payment field value
      i. Is the update method of the entry to add (mathematically) to the payment field's existing value?
         1. Yes: Convert the format-specific field value to a number using any included formatting settings. Add this value to the payment field's existing value. Go to Step 1.
      ii. Is the update method of the entry to subtract (mathematically) to the payment field's existing value?
         1. Yes: Convert the format-specific field value to a number using any included formatting settings. Subtract this value from the payment field's existing value. Go to Step 1.
      iii. Is the update method of the entry to append to the payment field's existing value?
         1. Yes: Append any specified join characters to the payment field's existing value. Then append the format-specific field value. Go to Step 1.
      iv. Is the update method of the entry to prepend to the payment field's existing value?
         1. Yes: Prepend any specified join characters to the payment field's existing value. Then prepend the format-specific field value. Go to Step 1.
      v. Is the update method of the entry to replace the payment field's existing value?
         1. Yes: Overwrite the payment field's existing value with the format-specific field value. Go to Step 1.

### Payment Field Normalization (PFN)

1. For each payment field that has a normalization entry in the FFD:
   a. For each character replacement entry defined in the payment field's normalization entry:
      i. For each instance of the payment field that matches the regular expression pattern provided in the character replacement entry
         1. Replace the payment field's value with the characters specified in the entry

### Payment Field Validation (PFV)

1. For each group in the abstract file
   a. For each payment transaction in the group
      i. Can the transaction's type be identified?
         1. Yes: Perform Transaction Validation (TV) on transaction.

### Transaction Validation (TV)

1. Is transaction allowed based on TTD?
   a. No: Store error in Results Dataset. Exit process.
2. For each transaction-level payment field defined in TTD:
   a. For each defined validation test in TTD:
      i. Based on evaluating conditions defined in the TTD, should test be run?
         1. No: Go back to Step 2a (i.e. try next test).
      ii. Perform test.
      iii. Did test pass?
         1. No: Store error message in Results Dataset. Go to Step 2c (i.e. skip remaining tests for payment field).
   b. Store success message (if specified in FFD) in Results Dataset.
   c. Update validation status of payment field in Results Dataset.

Thus, apparatus and methods for validating files for processing by an electronic payment system have been provided.

Persons skilled in the art will appreciate that the present invention can be practiced by other then the described embodiments, which are presented for purposes of illustration rather than of limitation, and that the present invention is limited only by the claims that follow.

What is claimed is:

1. Apparatus for facilitating electronic payments, the apparatus comprising:
a processor module; and
a memory storing instructions;
wherein the processor module executes the instructions, the instructions configured to:
map a field from a source file to a payment field;
normalize the payment field; and
validate the normalized payment field as acceptable by an electronic payment system.

2. The apparatus of claim 1 wherein the mapping comprises mapping the field into several portions of a payment field.

3. The apparatus of claim 1 wherein the mapping includes discarding a portion of the field.

4. The apparatus of claim 1 wherein the field comprises a plurality of elements and the mapping includes changing the order of the elements.

5. The apparatus of claim 1 wherein the mapping includes updating a portion of the field.

6. The apparatus of claim 1 wherein the payment field is a plurality of elements and the normalization comprises re-ordering the plurality of elements.

7. The apparatus of claim 1 wherein the field is a format-specific field.

8. The apparatus of claim 6 wherein the payment field is a format-agnostic rendering of the contents of the format-specific field.

9. The apparatus of claim 1 wherein the instructions are further configured to pre-process the source file.

10. The apparatus of claim 1 wherein the instructions are further configured to validate the field.

11. The apparatus of claim 1 wherein the field is a portion of a record and the instructions are further configured to validate the record.

12. The apparatus of claim 1 wherein the source file is a fixed width source file.

13. The apparatus of claim 1 wherein the source file is a character delimited file.

14. The apparatus of claim 1 wherein the source file is a XML file.

15. A method for facilitating electronic payment payments, the method comprising:
using a processor to map a field from a source file to a payment field;
using the processor to normalize the payment field; and
using the processor to validate the normalized payment field as acceptable by an electronic payment system.

16. The method of claim 15 wherein the mapping comprises mapping the field into several portions of a payment field.

17. The method of claim 15 wherein the mapping includes discarding a portion of the field.

18. The method of claim 15 wherein the field comprises a plurality of elements and the mapping includes changing the order of the elements.

19. The method of claim 15 wherein the mapping includes updating a portion of the field.

20. The method of claim 15 wherein the payment field is a plurality of elements and the normalization comprises re-ordering the plurality of elements.

21. The method of claim 15 wherein the field is a format-specific field.

22. The method of claim 21 wherein the payment field is a format-agnostic rendering of the contents of the format-specific field.

23. The method of claim 15 wherein the instructions are further configured to pre-process the source file.

24. The method of claim 15 wherein the instructions are further configured to validate the field.

25. The method of claim 15 wherein the field is a portion of a record and the instructions are further configured to validate the record.

26. The method of claim 15 wherein the source file is a fixed width source file.

27. The method of claim 15 wherein the source file is a character delimited file.

28. The method of claim 15 wherein the source file is a XML file.

29. One or more non-transitory, computer-readable, media storing computer-executable instructions which, when executed by a processor on a computer system, perform a method for approving a document, the method comprising:
using a processor to map a field from a source file to a payment field;
using the processor to normalize the payment field; and
using the processor to validate the normalized payment field as acceptable by an electronic payment system.
